(19) United States
(12) Patent Application Publication
(10) Pub. No.: US 2005/0199269 A1
(43) Pub. Date: Sep. 15, 2005

(54) Cleaning tanks

(76) Inventors: Scott Heil, Maidstone (CA); Kevin Hallet, Lashburn (CA)

Correspondence Address: JOHN F. SALAZAR;MIDDLETON & REUTLINGER, 2500 BROWN & WILLIAMSON TOWER, LOUISVILLE, KY, 40202, US

(21) Appl. No.: 11/075,975

(22) Filed: Mar. 9, 2005

(30) Foreign Application Priority Data
Mar. 10, 2004 (CA) 2,460,542

(51) Int. Cl. B08B 3/12

(52) U.S. Cl. 134/21; 134/172; 134/166 R; 134/167 R

(57) ABSTRACT

A cleaning adapter apparatus comprises a swivel support device adapted to be sealed over a wall aperture in the lower portion of the tank wall. A swiveling body defines a cleaning channel therethrough and is sealed in the swivel support device such that the swiveling body can move horizontally with an outer end of the cleaning channel exposed on an outside of the tank, and an inner end exposed on an inside of the tank. A valve is connected to the outer end of the cleaning channel and is adapted for connection to a vacuum tube and internal pressure wand of a vacuum truck such that the pressure wand can pass through the valve and cleaning channel into the tank. The pressure wand can be moved from side to side in addition to in and out while cleaning the tank with the method of the invention.

This invention is in the field of tanks and like storage containers and in particular apparatuses and methods used in the cleaning of sediment from tanks such as are used in oil storage.

### BACKGROUND

Storage tanks and similar containers are used in a number of industries as a temporary storage site for a wide variety of materials. One such example is storage tanks used to hold crude oil. In areas where access to a pipeline is not available, storage of crude oil after extraction from the well is necessary until such time as the oil can be removed to a refinery, typically using a tanker truck.

A problem with the storage of crude oil extracted from underground formations is that it commonly contains suspended sediments such as sand. During the extraction process, these sediments remain in suspension however once the crude oil is in a storage tank, these sediments settle to the bottom of the tank, accumulating over time. If allowed to accumulate, these sediments will eventually cause blockage of outlet ports in the tank through which the oil is normally removed.

Should these ports become blocked, it is usually necessary to completely drain the tank, disassemble it, and then clean out the sediments. This is an expensive and time-consuming process that creates the risk of environmental pollution during the removal of the crude oil trapped in the tank. In addition, a replacement tank must be provided if continued production from the wellhead is desired during the time the fouled tank is being serviced.

As a result, it is common practice in the field to attempt to clean sediments out of tanks on a regular basis, in order to keep sediment levels from interfering with the removal of oil from the tank. There are a variety of manual and mechanized prior art methods of cleaning sediments from oil storage tanks. Manual methods suffer from the common problem that they are tedious, time-consuming and that they expose the worker to potentially hazardous substances. Mechanized methods have been developed that avoid workers entering tanks.

The typical method for cleaning oil field tank involves inserting a pressure wand through a port located in the tank wall just above the floor of the tank. Such ports are provided on the tank and have a valve closing the port that has exposed threads for attachment of various fittings as might be required. When cleaning is required a crew arrives at the tank and threads a cleaning assembly onto the valve. The cleaning assembly typically comprises a large vacuum tube threaded into the valve and attached to a vacuum truck that applies suction to the interior of the vacuum tube. A smaller pressure tube or wand is slidingly sealed in the outer end of the vacuum tube, and a pressurized water supply, typically mounted on a separate pressure truck, is connected to the wand to supply high-pressure water to the wand. The valve is then opened and the wand is pushed into the tank. The high-pressure water stream dislodges the sediment and then the resulting slurry of water and sediment is aspirated into the vacuum truck through the annulus between the inner wall of the vacuum tube and the outer wall of the wand. The wand is pushed forward, dislodging the sediment as it goes, until it has reached the opposite wall of the tank. The wand may be moved back and forth several times to remove as much sediment as possible.

The portion of the tank that is effectively cleaned comprises a relatively narrow strip emanating from the site of the port to the opposite wall of the tank. As a result, a significant portion of the bottom of the tank remains covered in sediment necessitating more frequent cleaning in order to prevent blockage of the ports by sediments. A way in which this type of limitation has been addressed is to fit a tank with multiple entry ports. This is a less than desirable solution as it increases the complexity of the tanks and hence the cost to manufacture. In addition it means that in order to fully clean the tank bottom of sediment, multiple operations are required, increasing the time and effort needed to properly clean the tank.

Considerable prior art is directed to various means and methods for cleaning tanks, for example as disclosed by U.S. Pat. No. 6,371,137 to Heath, U.S. Pat. No. 3,895,756 to Jaeger, U.S. Pat. No. 5,460,331 to Krajicek et al., and U.S. Pat. No. 5,195,548 to Roger.

### SUMMARY OF THE INVENTION

It is an object of the present invention to provide an adapter apparatus and method for use in cleaning sediment from storage tanks that overcomes limitations in the prior art.

The invention provides, in one embodiment, a cleaning adapter apparatus for attachment to a lower portion of a tank wall. The apparatus comprises a swivel support device adapted to be fixed to the tank wall over a wall aperture in the lower portion of the tank wall such that the swivel support device is sealed to the tank wall. A swiveling body defines a cleaning channel therethrough and is sealed in the swivel support device such that the swiveling body can move at least horizontally and such that an outer end of the cleaning channel is exposed on an outside of the tank, and an inner end of the cleaning channel is exposed on an inside of the tank when the swivel support device is fixed to the tank wall. A valve is connected to the outer end of the cleaning channel and is adapted for connection to a vacuum tube with an internal pressure wand such that the pressure wand can pass through the valve and cleaning channel into the tank, and the wand then connected to pressure truck for cleaning the tank.

The invention provides in a second embodiment a tank and cleaning apparatus comprising a swiveling body defining a cleaning channel therethrough and sealed in a lower portion of a tank wall such that the swiveling body can move at least horizontally and such that an outer end of the cleaning channel is exposed on an outside of the tank, and an inner end of the cleaning channel is exposed on an inside of the tank. A valve is connected to the outer end of the cleaning channel and is connected by a vacuum tube to a vacuum source. A pressure wand is operatively connected to a pressurized liquid source and slidably sealed inside the vacuum tube such that the pressure wand can slide inside the vacuum tube and through the valve and the cleaning channel such that a nozzle end of the pressure wand is inside the tank.

The invention provides in a third embodiment method of cleaning sediment from a tank with a vacuum tube that includes a pressure wand slidably sealed inside the vacuum tube. The method comprises providing a swiveling body defining a cleaning channel therethrough and sealed in a lower portion of a tank wall such that the swiveling body can move at least horizontally and such that an outer end of the cleaning channel is exposed on an outside of the tank, and an inner end of the cleaning channel is exposed on an inside of the tank, and providing a valve having a first port connected to the outer end of the cleaning channel; connecting the vacuum tube to a second port of the valve and opening the valve; pushing the pressure wand through the valve and the cleaning channel into the tank and pushing the pressure wand back and forth and substantially horizontally from side to side while directing a flow of pressurized water through the pressure wand and drawing a sediment slurry out of the tank through the vacuum tube.

A high-pressure pressure wand is inserted through the swiveling body into the tank in a conventional manner. Horizontal movement of the swiveling body permits an operator to achieve improved coverage of the tank bottom during cleaning operations. The dislodged sediments can be sucked out of the tank in the space between the walls of the vacuum tube and the wand by a vacuum truck in a conventional manner.

The adapter apparatus of the invention provides for removal of a greater amount of the sediments in a tank, without the need to empty, decommission or disassemble the tank, and via a single port of entry into the tank. The adapter apparatus is simple and readily adapted to existing oil storage tanks. In construction of new tanks a swiveling body and swivel support device can be incorporated into a lower portion of the tank wall

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic side view of an embodiment of the present invention as installed in the side of an oil storage tank;

FIG. 2A is a schematic top view showing the cleaning pattern obtained with a prior art device the apparatus of the present invention; and

FIG. 2B is a schematic top view showing the cleaning pattern obtained with the apparatus of the present invention.

FIG. 3 is a perspective exploded more detailed view of the embodiment of FIG. 1 showing stop plates added to the outer retaining flange;

FIG. 4 is a side view of the adapter apparatus of FIG. 3.

### DETAILED DESCRIPTION OF THE ILLUSTRATED EMBODIMENTS

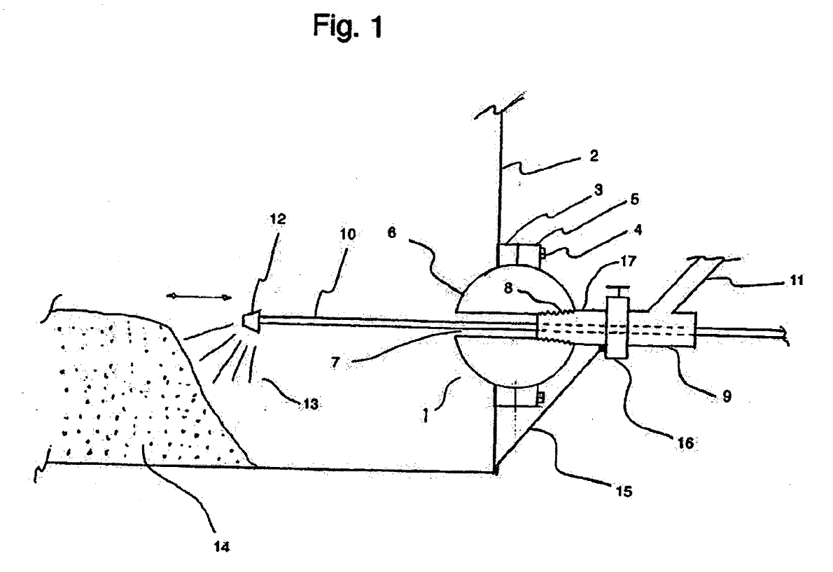

FIG. 1 schematically illustrates a tank cleaning system comprising an embodiment of the cleaning adapter apparatus 1 of the invention mounted on a lower portion of the wall 2 of a tank, such as an oil storage tank. The cleaning adapter apparatus 1 comprises a swivel support device adapted to be fixed to the tank wall over a wall aperture in the lower portion of the tank wall such that the swivel support device is sealed to the tank wall. In the illustrated embodiment the swivel support device is provided by inner and outer retaining flanges 3, 5.

A swiveling body defines a cleaning channel therethrough and is sealed in the swivel support device such that the swiveling body may move horizontally and such that an outer end of the cleaning channel is exposed on an outside of the tank, and an inner end of the cleaning channel is exposed. In the illustrated embodiment the swiveling body is provided by a spherical gimbal 6.

In the illustrated embodiment the inner retaining flange 3, is attached over an aperture in the wall 2 of the tank. The inner retaining flange 3 can be attached by permanent methods such as welding as illustrated, or by non-permanent methods using conventional fasteners such as nut and bolt combinations and the like. The outer retaining flange 5 is attached to the inner retaining flange 5 by bolts 4 threaded into threaded holes in the inner retaining flange 3.

The spherical gimbal 6 is sealed between the retaining flanges 3, 5. The inner surfaces of the inner and outer retaining flanges 3, 5 are formed such that when affixed to each other they form a cavity operative to receive and hold the gimbal 6 in place. Conveniently, the dimensions of the cavity formed by the flanges 3, 5 are such that when the gimbal 6 is placed between the inner and outer retaining flanges 3, 5, fastening of the flanges clamps the gimbal 6 in place with sufficient force to seal the gimbal 6 while still allowing it to move relatively freely.

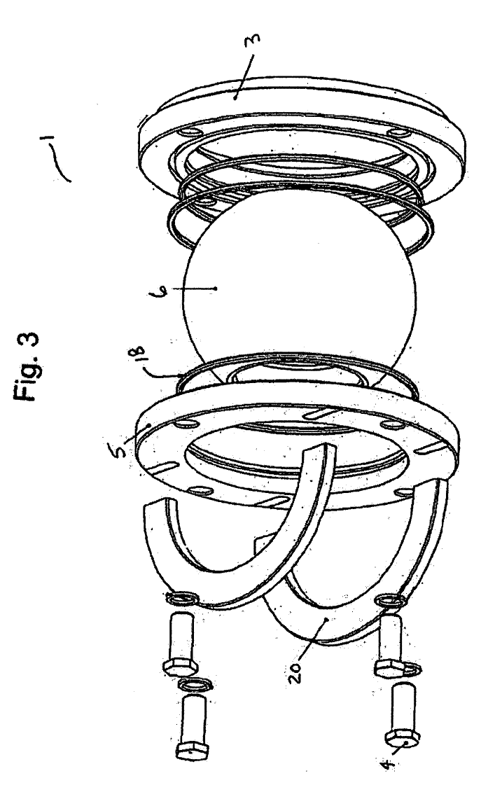

In the illustrated embodiment, fastening of the two flanges is by bolts 4 as illustrated in FIG. 3, allowing for ease of access to the gimbal 6 that is mounted between the inner and outer retaining flanges 3, 5, for routine maintenance or repairs as may be required from time to time. As illustrated in FIG. 3, the flange and gimbal assembly further comprises seals 18 engaging grooves in the retaining flanges 3, 5, which are operative to prevent leakage of the tank contents past the outer surface of the gimbal 6.

The gimbal 6 defines a cleaning channel 7 therethrough such that an outer end of the cleaning channel 7 is exposed on an outside of the tank, and an inner end of the cleaning channel 7 is exposed on an inside of the tank, and through which a wand may be inserted to gain access to the interior of the tank. A nipple 17 is threaded into threads 8 in the outer end of the cleaning channel 7. The nipple 17 is hollow, and closed at an outer end with a gate valve 16.

The gimbal 6, flanges 3, 5, nipple 17 and gate valve 16 are installed on a tank in place of the fixed port and gate valve that is conventionally used to attach a cleaning assembly to clean sediment from the tank. The conventional cleaning assembly comprises a hollow vacuum tube 9, and a pressure wand 10 sealed to the vacuum tube 9 and slidable along an axis of the vacuum tube 9 such that the pressure wand 10 can move in and out of the tank along the axis of the vacuum tube 9.

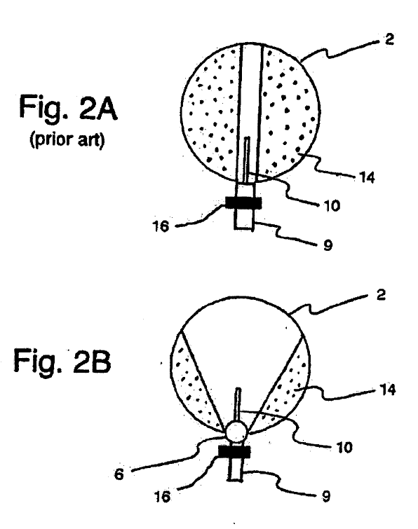

Conventionally, the vacuum tube 9 is threaded into the gate valve 16 and the valve is opened to allow the pressure wand 10 to move into the tank 2. A pressure truck supplies high-pressure water to the pressure wand 10 to produce a focused high-pressure jet 13 of water through the nozzle 12 which dislodges the sediment 14. The resulting slurry of water and sediment is aspirated out through the outer portion of the nipple 17, valve 16, and vacuum tube 9, around the pressure wand 10, into a vacuum truck through the vacuum outlet 11. The pressure wand 10 can be pushed through the fixed port to the opposite side of the tank 2, dislodging sediment 14 in a strip from the port to the opposite wall as illustrated in FIG. 2A.

The adapter apparatus 1 of the present invention provides a swiveling port to which the nipple 17 and valve 16 is attached. The conventional cleaning assembly is attached to the valve 16 in the same manner as before, by threading the vacuum tube 9 into the threads on the gate valve 16. However the gimbal 6 allows the pressure wand to be moved not only in and out, but from side to side and, if desired, up and down, allowing sediment 14 in the much larger area shown in FIG. 2B to be removed.

The valve 16 and nipple 17 can conveniently be mounted on a pivoting support arm 15. The support arm 15 serves to keep the tube 9 in a substantially horizontal orientation, while still permitting a side to side motion of the pressure wand, such that the pressure wand 10 is placed in a position suited for efficient cleaning of the tank bottom. Mounting the tube 9 on the support arm 15 provides relief for the operator, such that the operator is not required to manually control the tube 9. Typically when cleaning such tanks it is not desirable to have the nozzle 12 drag or rub along the tank floor, causing wear. As well when using the illustrated gimbal 6 that allows movement vertically as well as horizontally the pressure wand 10 tends to rise as it encounters sediment, and it is necessary to hold the nozzle end down. The support arm 15 thus limits vertical movement of the pressure wand 10, decreasing the effort that must be expended by an operator when using the cleaning system.

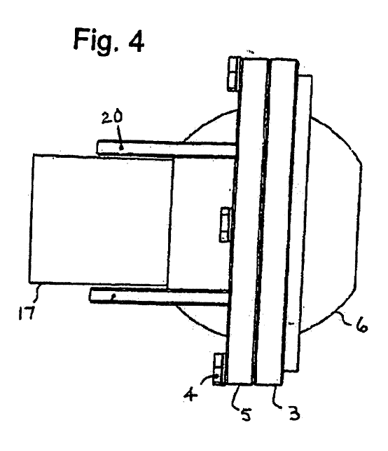

With the support arm 15 removed, the gimbal 6 can be moved up and down as well as side to side. FIGS. 3 and 4 illustrate an alternate device for limiting vertical movement of the nipple 17, and thus the attached valve and vacuum tube. Upper and lower stop plates 20 are fixed to the outer retaining flange 5 such that the nipple 17 extends between the stop plates 20 and vertical movement thereof is limited. In the illustrated embodiment the stop plates 20 are welded to the outer retaining flange 5 and so this particular device will only be used where it is contemplated that vertical movement will not be required at any time. Alternatively the stop plates 20 could be attached to the outer retaining flange 5 by bolts or like fasteners.

Although the spherical gimbal 6 and cooperating retaining flanges 3, 5 are convenient and economical to manufacture, other shapes for the swiveling body and swivel support could provide the required function as well. For example a vertically oriented cylindrical or oblong body could be substituted for the spherical gimbal 6, and suitably sealed to the tank wall 2 such that side to side movement is available, but up and down movement is prevented.

Thus the invention provides a swiveling body defining a cleaning channel therethrough, for example as illustrated as gimbal 6. The swiveling body is sealed in a lower portion of the tank wall such that the swiveling body may move at least horizontally and such that an outer end of the cleaning channel is exposed on an outside of the tank, and an inner end of the cleaning channel is exposed on an inside of the tank, for example as illustrated by the swivel support device comprising retaining flanges 3, 5. A valve is operative to close the cleaning channel and has a first port connected to the outer end of the cleaning channel and a second port adapted for connection to a tube from a vacuum truck in a conventional manner, as illustrated by gate valve 16 and nipple 17. When the vacuum tube is connected the valve can be opened, and the tank cleaned by pushing the pressure wand through the valve and the cleaning channel into the tank and pushing the pressure wand back and forth and substantially horizontally from side to side while directing a flow of pressurized water through the pressure wand and drawing a sediment slurry out of the tank through the vacuum tube.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A cleaning adapter apparatus for attachment to a lower portion of a tank wall, the apparatus comprising:
a swivel support device adapted to be fixed to the tank wall over a wall aperture in the lower portion of the tank wall such that the swivel support device is sealed to the tank wall;
a swiveling body defining a cleaning channel therethrough and sealed in the swivel support device such that the swiveling body can move at least horizontally and such that an outer end of the cleaning channel is exposed on an outside of the tank, and an inner end of the cleaning channel is exposed on an inside of the tank when the swivel support device is fixed to the tank wall;
a valve connected to the outer end of the cleaning channel and adapted for connection to a vacuum tube with an internal pressure wand such that the pressure wand can pass through the valve and cleaning channel into the tank.

2. The apparatus of claim 1 further comprising a valve having a first port connected to the outer end of the cleaning channel and a second port adapted for connection to a tube.

3. The apparatus of claim 1 wherein the swivel support device comprises an inner retainer flange having a tank face adapted to be fixed to the tank wall such that the inner flange is sealed to the tank wall, and an outer retaining flange attached to the inner retaining flange, and wherein the swiveling body is sealed between the inner and outer retaining flanges.

4. The apparatus of claim 3 wherein the swiveling body is a spherical gimbal and is sealed between the inner and outer retaining flanges such that the gimbal can move horizontally and vertically.

5. The apparatus of claim 4 further comprising a support rod adapted to limit vertical movement of the swiveling body.

6. The apparatus of claim 4 further comprising upper and lower stop plates fixed to the outer retaining flange and oriented to limit upward and downward movement of a tube passing through the cleaning channel.

7. A tank and cleaning apparatus comprising:
a swiveling body defining a cleaning channel therethrough and sealed in a lower portion of a tank wall such that the swiveling body can move at least horizontally and such that an outer end of the cleaning channel is exposed on an outside of the tank, and an inner end of the cleaning channel is exposed on an inside of the tank;
a valve connected to the outer end of the cleaning channel and connected by a vacuum tube to a vacuum source;
a pressure wand operatively connected to a pressurized liquid source and slidably sealed inside the vacuum tube such that the pressure wand can slide inside the vacuum tube and through the valve and the cleaning channel such that a nozzle end of the pressure wand is inside the tank.

8. The apparatus of claim 7 wherein the swiveling body is sealed between an inner retainer flange sealed to the tank wall and an outer retaining flange attached to the inner retaining flange.

9. The apparatus of claim 8 wherein the swiveling body is a spherical gimbal and is sealed between the inner and outer retaining flanges such that the gimbal can move horizontally and vertically.

10. The apparatus of claim 9 further comprising a support rod adapted to limit vertical movement of the swiveling body.

11. The apparatus of claim 9 further comprising upper and lower stop plates fixed to the outer retaining flange and oriented to limit upward and downward movement of the valve.

12. A method of cleaning sediment from a tank with a vacuum tube that includes a pressure wand slidably sealed inside the vacuum tube, the method comprising:
providing a swiveling body defining a cleaning channel therethrough and sealed in a lower portion of a tank wall such that the swiveling body can move at least horizontally and such that an outer end of the cleaning channel is exposed on an outside of the tank, and an inner end of the cleaning channel is exposed on an inside of the tank;
providing a valve having a first port connected to the outer end of the cleaning channel;
connecting the vacuum tube to a second port of the valve and opening the valve;
pushing the pressure wand through the valve and the cleaning channel into the tank and pushing the pressure wand back and forth and substantially horizontally from side to side while directing a flow of pressurized water through the pressure wand and drawing a sediment slurry out of the tank through the vacuum tube.

13. The method of claim 12 wherein the swiveling body is spherical gimbal sealed between inner and outer retaining flanges such that the gimbal can move horizontally and vertically.

14. The method of claim 13 further comprising limiting vertical movement of the gimbal.

15. The method of claim 13 further comprising upper and lower stop plates fixed to the outer retaining flange and oriented to limit upward and downward movement of the vacuum tube.
